(19) United States
(12) Patent Application Publication
(10) Pub. No.: US 2008/0018448 A1
(43) Pub. Date: Jan. 24, 2008

(54) System and method for tire pressure monitoring

(75) Inventors: Riad Ghabra, Dearborn Heights, MI (US); Qingfeng Tang, Novi, MI (US); John S. Nantz, Brighton, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/542,367

(22) Filed: Oct. 3, 2006

Related U.S. Application Data
(63) Continuation-in-part of application No. 11/458,212, filed on Jul. 18, 2006.

(51) Int. Cl. B60C 23/00

(52) U.S. Cl. 340/447

(57) ABSTRACT

A system for monitoring at least one parameter of vehicle tire includes a receiver and a transmitter. The transmitter corresponds to the tire and has a programmable memory storing a code and one of a set of locally unique identifiers. The transmitter generates an encrypted portion of a transmitted signal based on the locally unique identifier and the code. The transmitter generates a data portion of the transmitted signal based on sensing at least one parameter of the tire. The receiver stores a set of locally unique identifiers and the code. The receiver receives the transmitted signal. The encrypted portion is decrypted using at least one of the code and the locally unique identifiers to produce a decrypted portion. A check is made to determine if the decrypted portion matches one of the code and the locally unique identifiers and, if so, the data portion is processed.

### CROSS-REFERENCE TO RELATED APPLICATIONS

This application is a continuation-in-part of U.S. application Ser. No. 11/458,212 filed Jul. 18, 2006, which is herein incorporated by reference.

### BACKGROUND OF THE INVENTION

1. Field of the Invention

The present invention relates to a system and method for tire pressure monitoring.

2. Background

Conventional vehicle tire pressure monitoring systems generally comprise a plurality of transmitters. Each transmitter is generally associated with a tire of the vehicle and conveys a signal corresponding to the air pressure in the tire to a receiver mounted on the vehicle. In addition, each transmitter is generally pre-configured, for example during a manufacturing process, with a unique identifier that it attaches to the tire pressure signal. The unique identifier allows the receiver to associate a received signal with the transmitter that generated the signal. Accordingly, each transmitter must write (i.e., teach) its unique identifier to the receiver during a pairing (i.e., teaching) process.

The unique identifier serves at least two purposes. First, the unique identifier is used to determine from which tire a transmitted pressure is received. Second, the unique identifier is used to prevent processing a signal transmitted from a tire on a different vehicle.

Because such prior art tire pressure monitoring systems require each transmitter to write a unique identifier to the receiver, care must be taken during the manufacturing and/or pairing process to insure that transmitters pre-configured with identical identifiers are not implemented with the same receiver.

### SUMMARY OF THE INVENTION

Accordingly, it may be desirable to have a system and method for monitoring tire parameters, such as pressure and temperature, that may provide a reduction in cost and/or manufacturing complexity by reducing or eliminating the need to insure that only transmitters pre-configured with unique identifiers are implemented with a given receiver. Accordingly, one embodiment of the present invention provides for a parameter transmitter that generates an encrypted signal based on a locally unique identifier and a receiver code.

A system for monitoring at least one parameter of vehicle tire is provided. The system includes a receiver and a transmitter. The receiver has a storage memory storing a set of locally unique identifiers and a code. The receiver receives a transmitted signal with an encrypted portion and a data portion. The encrypted portion is decrypted using at least one of the code and the locally unique identifiers to produce a decrypted portion. A check is made to determine if the decrypted portion matches one of the code and the locally unique identifiers and, if so, the data portion is processed. The transmitter corresponds to the tire and has a programmable memory storing the code and one of the set of locally unique identifiers. The transmitter generates the encrypted portion based on the stored locally unique identifier and the code. The transmitter generates the data portion based on sensing at least one parameter of the tire. The transmitter transmits transmit the transmitted signal including the encrypted portion and the data portion.

In an embodiment of the present invention, the transmitter generates the encrypted portion by encrypting the code with the stored locally unique identifier. The receiver may then decrypt the encrypted portion using one of the set of locally unique identifiers and determine if the decrypted portion matches the code.

In another embodiment of the present invention, the transmitter generates the encrypted portion by encrypting the stored locally unique identifier with the code. The receiver may then determine if the decrypted portion matches a member of the set of locally unique identifiers.

In still another embodiment of the present invention, the transmitter further includes a low frequency receiver. The transmitter is configured to receive at least one of the code and a locally unique identifier via the low frequency receiver. The receiver may include a low frequency initiator for transmitting at least one of the code and a locally unique identifier via the low frequency receiver. A tool may be electronically coupled to the transmitter for transmitting an operator initiated signal to the transmitter. The transmitter transmits a pairing request signal to the receiver in response to the operator initiated signal.

A method for monitoring a vehicle tire is also provided. A locally unique tire identifier and a code are stored in a transmitter. An encrypted portion of a transmission signal is generated based on the locally unique tire identifier and the code. A data portion of the transmission signal is generated based on at least one parameter sensed for the vehicle tire. The transmission signal is transmitted from the transmitter.

A method for monitoring a particular tire on a particular vehicle is also provided. A locally unique identifier is assigned to the particular tire. Each locally unique identifier is different from any other tire identifier associated with a receiver on the particular vehicle but is not necessarily different from any other tire identifier associated with a different vehicle. A unique code is assigned to the receiver. The receiver receives a transmission signal including an encrypted portion and a data portion. The encrypted portion is decrypted using at least one of the code and at least one of the locally unique identifiers to generate a decrypted portion. The decrypted portion is compared to at least one of the code and the at least one of the locally unique identifiers and, if the comparison results in a match, the data portion is processed.

The above objects and other objects, features, and advantages of the present invention are readily apparent from the following detailed description when taken in connection with the accompanying drawings.

### BRIEF DESCRIPTION OF THE DRAWINGS

FIG. 1 is a schematic diagram illustrating an embodiment of the present invention implemented in connection with a vehicle;

FIG. 2 is a system for monitoring one or more parameters such as air pressure in a tire of a vehicle according to an embodiment of the present invention;

FIG. 3 is a flow diagram of a method for monitoring one or more parameters such as air pressure in a tire of a vehicle and a flow diagram of a method for pairing a transmitter and a receiver in a system for monitoring one or more parameters such as air pressure in a tire according to one or more embodiments of the present invention;

FIG. 4 is a flow diagram illustrating a method of generating and transmitting a signal according to an embodiment of the present invention;

FIG. 5 is a flow diagram illustrating receiving a signal according to an embodiment of the present invention;

FIG. 6 is a flow diagram illustrating an alternative method of generating and transmitting a signal according to an embodiment of the present invention; and

FIG. 7 is a flow diagram illustrating receiving a signal according to an alternative embodiment of the present invention.

### DETAILED DESCRIPTION

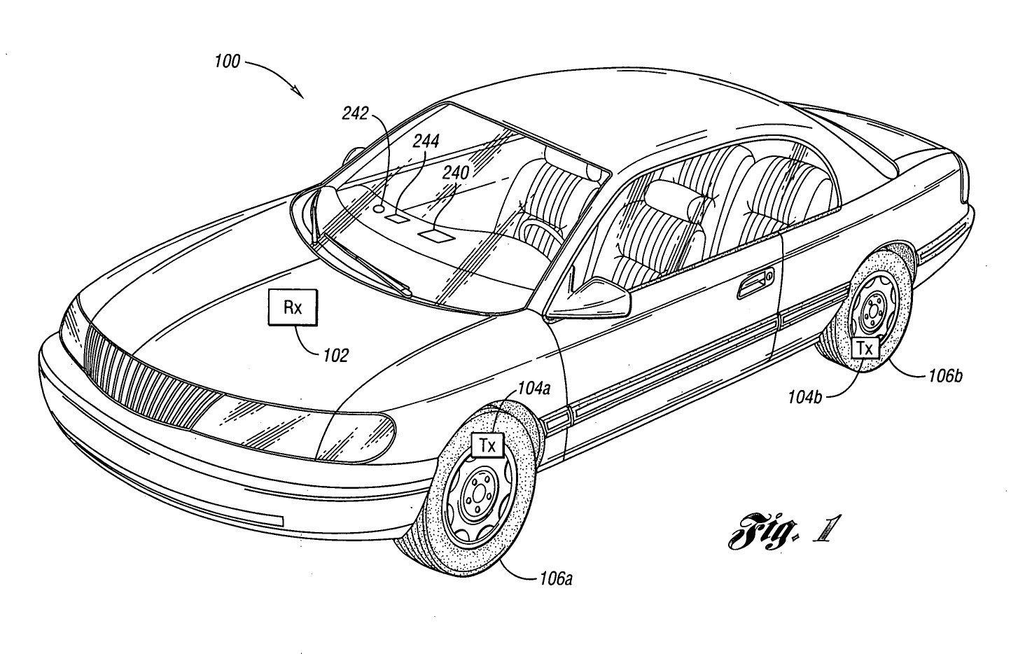

Referring to FIG. 1, a schematic diagram is provided illustrating one embodiment of the present invention implemented in connection with a vehicle 100 (i.e., automobile, truck, etc.). As illustrated, the present invention generally comprises a receiver 102 in electronic communication (e.g., wireless communication) with one or more transmitters 104 (e.g., 104a, 104b, etc.). Each transmitter 104 generally corresponds to a tire 106 (e.g., 106a, 106b, etc.) of the vehicle 100 and is configured to transmit a signal corresponding to the air pressure in the corresponding tire 106.

In at least one embodiment, a single transmitter 104 may be implemented in connection with a single tire 106 of the vehicle 100, such as a spare tire (not shown). In at least one other embodiment, a plurality of transmitters 104 may be implemented such that one transmitter 104 corresponds to each tire 106 of the vehicle 100. However, any appropriate number of transmitters 104 may be implemented to meet the design criteria of a particular application.

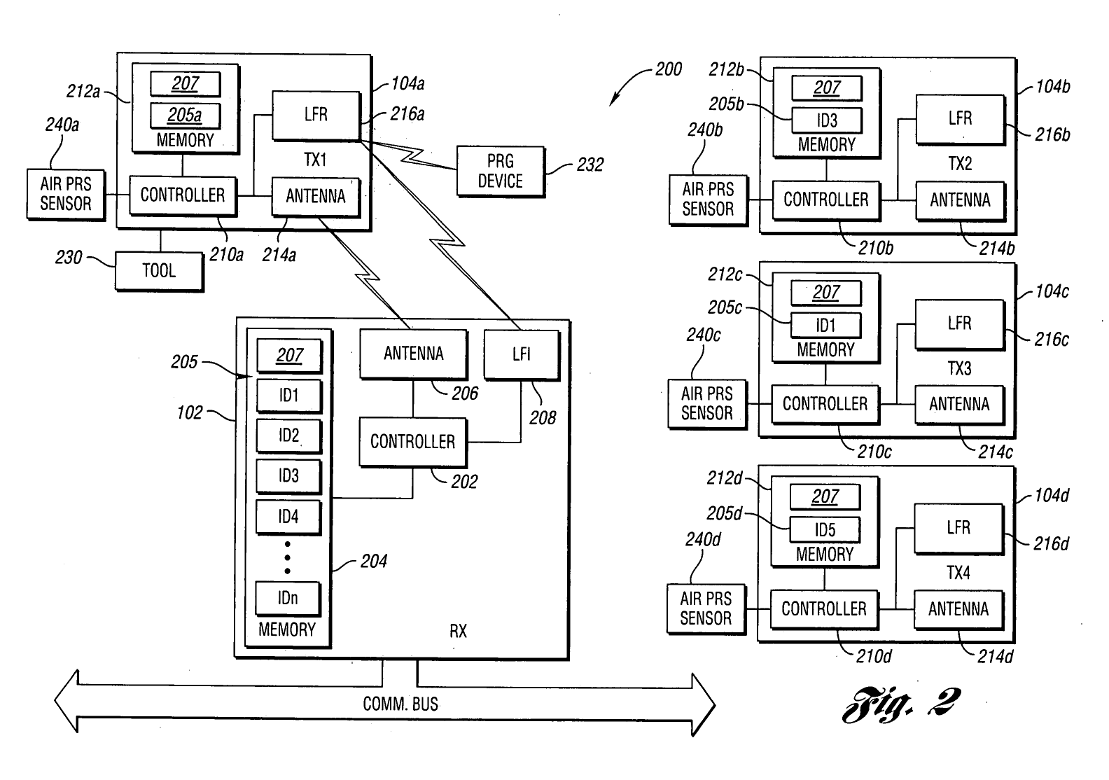

Referring to FIG. 2, a system 200 is provided for monitoring air pressure in a tire 106 of a vehicle 100 according to an embodiment of the present invention. As previously illustrated in FIG. 1, the system 200 generally comprises a receiver (Rx) 102 and one or more transmitters 104 (e.g., Tx1-Tx4; 104a-104d).

The receiver 102 generally comprises Rx controller 202, a storage memory 204, and an antenna 206 for receiving/transmitting a signal from/to an antenna 214 of a transmitter 104. In at least one embodiment, the receiver 102 may optionally comprise a low frequency initiator (LFI) 208 for transmitting a signal to a low frequency receiver (LFR) 216 of the transmitter 104.

In general, the Rx controller 202 may be a computer or other electronic component (i.e., logical device) which executes a program and/or which performs other logical exercises, such as an application specific integrated circuit (i.e., ASIC) and/or the like. It is contemplated that all or part of the functionality of the components represented by the Rx controller 202 may be incorporated into a single controller, such as the Rx controller 202 illustrated in FIG. 2. Alternatively, the components and/or functionality represented by the Rx controller 202 may be distributed among a plurality of controllers (not shown). Controller inputs and outputs may be received and passed between controllers via a network, dedicated communication wires, and the like.

The storage memory 204 of the receiver 102 may be any suitable data storage device (e.g., a Random Access Memory, a Flash Memory, an Electronically Erasable Programmable Read Only Memory, a Read Only Memory, and/or the like) in electronic communication with the Rx controller 202 for holding (i.e., retrievably storing) a set of identifiers (e.g., ID1-IDn), referred to generally as 205, and a code 207. In general, use of a Read Only Memory as the storage memory 204 may, in one or more embodiments, provide a reduction in the cost of manufacturing the associated receiver 102.

The set of identifiers 205 generally comprises one or more unique members (i.e., one or more unique identifiers; 205a, 205b, etc.), such as, for example, the identifier ID2. The identifiers are locally unique. In one embodiment, this means that each identifier is different from any other identifier used on a particular vehicle, but may be the same as an identifier used in a different vehicle. In another embodiment, with a plurality of receivers each servicing a subset of the transmitters, the identifiers need only be unique for each receiver. While the identifiers have been generally represented in FIG. 2 as ID1-IDn, it should be understood that any appropriate identifier having any appropriate format may be implemented to meet the design criteria of a particular application. In at least one embodiment, the set of identifiers 205 and/or the code 207 is written to (i.e., stored in) the storage memory 204 during the manufacturing process of the receiver 102. Furthermore, in one or more embodiments, the set of identifiers 205 and/or the code 207 may be unmodifiable once written to the storage memory 204.

Each transmitter 104 is generally electronically coupled to any appropriate sensor 240 for determining the air pressure and/or temperature in a corresponding tire 106. Each transmitter 104 may comprise a Tx controller 210, a writable (i.e., programmable) memory 212, and the antenna 214. In at least one embodiment, the transmitter 104 may optionally comprise the low frequency receiver (LFR) 216 for receiving a signal from the LFI 208.

In general, the Tx controller 210 may be a computer or other electronic component (i.e., logical device) which executes a program and/or which performs other logical exercises, such as an ASIC. It is contemplated that all or part of the functionality of the components represented by the Tx controller 210 may be incorporated into a single controller, such as the Tx controller 210 illustrated in FIG. 2. Alternatively, the components and/or functionality represented by the Tx controller 210 may be distributed among a plurality of controllers (not shown). Controller inputs and outputs may be received and passed between controllers via a network, dedicated communication wires, and the like.

In at least one embodiment, each transmitter 104 may be configured to receive and store a locally unique member (i.e., locally unique identifier) of the set of unique identifiers 205 and/or the code 207 from the receiver 102.

In at least one embodiment, the transmitter may be configured to receive the locally unique member of the set of unique identifiers 205 and/or the code 207 corresponding to the receiver 102 via the low frequency receiver 216. For example, the receiver 102 may be configured to transmit a unique member 205 and/or the code 207 to the transmitter 104 via the low frequency initiator 208. In another exemplary embodiment, a tool 230 may be electronically coupled (e.g., wired, wirelessly, etc.) to the transmitter 104 for transmitting an operator initiated signal to the transmitter 104. The transmitter 104 may transmit a pairing request signal to the receiver via the antenna 214 in response to the operator initiated signal. In response to the pairing request signal, the receiver 102 may transmit a locally unique identifier 205i and/or code 207 to the low frequency receiver 216 of the transmitter 104 via the low frequency initiator 208 of the receiver 102. In yet another exemplary embodiment, a programming device 232 may be used (e.g., during the manufacture of the transmitter 104) to convey (i.e., transmit, write, etc.) a locally unique member 205i and/or code 207 to the transmitter 104, such as via the LFR 216. In still another embodiment, the transmitter 104 and/or receiver 102 may be a transceiver and the locally unique member 205i and/or code 207 may be conveyed to the transmitter 104 using the antenna 214 and/or the antenna 206. However, a locally unique member of the set of unique identifiers 205 and/or code 207 corresponding to the receiver 102 may be transmitted to a transmitter 104 in response to any appropriate trigger and using any appropriate communication apparatus to meet the design criteria of a particular application.

In general, the locally unique member and/or code 207 may be stored in the programmable memory 212. Accordingly, the programmable memory 212 is generally configured to receive and retrievably store the locally unique member 205i and/or code 207 during programming (i.e., pairing) of the transmitter 104 and the receiver 102. In at least one embodiment, the programmable memory 212 may be a Random Access Memory (i.e., RAM). In at least one other embodiment, the programmable memory 212 may be a Flash Memory. However, the programmable memory 212 may be any suitable data storage device in electronic communication with the Tx controller 110 for receiving and/or holding (i.e., retrievably storing) an identifier 205i and/or code 207 corresponding to the receiver 102.

When the transmitter 104 has been paired with the receiver 102 (i.e., when that transmitter 104 has received and stored the unique member), the transmitter 104 generally uses the antenna 214 to transmit a signal (e.g., a signal PRS) based on the locally unique member 205i, code 207, and sensed signal (e.g., the air pressure and/or temperature in a corresponding tire 106 to the receiver 102).

In at least one embodiment, the receiver 102 may be configured to receive a signal (e.g., the signal PRS) from a transmitter 104, determine when the signal corresponds to a member of the set of locally unique identifiers 205, and process the signal when the signal corresponds to a member of the set of locally unique identifiers 205. Similarly, the receiver 102 may be configured to discard the signal when the signal does not correspond to a member of the set of unique identifiers 205. In one embodiment, the receiver 102 may receive the signal from the transmitter 104 via the antenna 206.

In at least one embodiment, the controller 202 processes the signal by transmitting a display signal corresponding to the air pressure and/or temperature to a display 240 (shown in FIG. 1) in an interior of the vehicle 100. In at least one other embodiment, the controller 202 processes the signal by generating an audible alarm 242 (shown in FIG. 1) and/or a visual alarm 244 (shown in FIG. 1) when the air pressure in the tire 106 is greater than a predetermined maximum threshold or less than a predetermined minimum threshold. However, the controller 202 may perform any appropriate step when the locally unique member 205i corresponding to the signal matches a member of the set of locally unique identifiers 205 to meet the design criteria of a particular application.

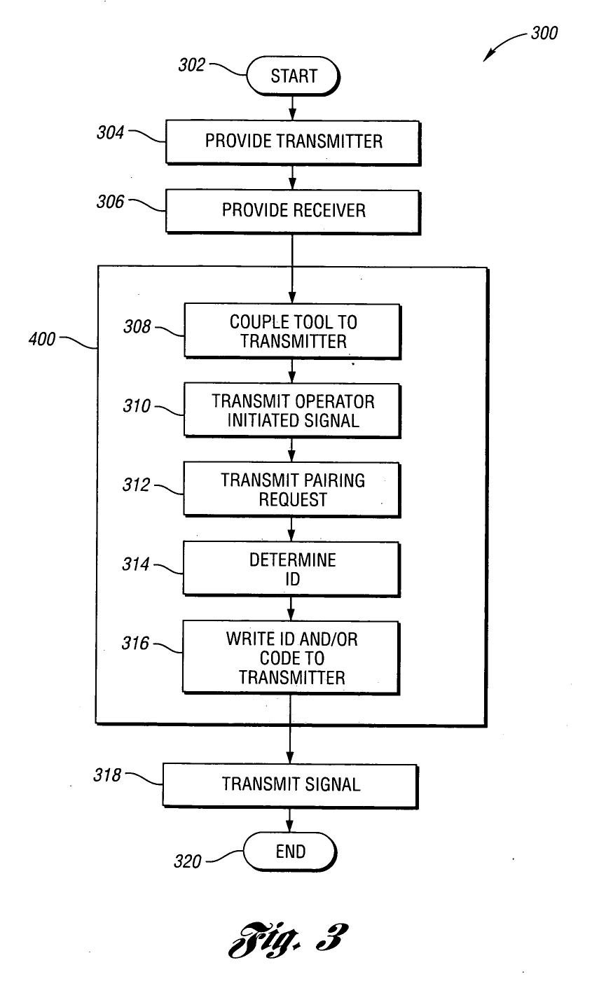

Referring to FIG. 3, a flow diagram of a method 300 for monitoring air pressure in a tire (e.g., 106) of a vehicle (e.g., 100) according to one embodiment of the present invention is shown. The method 300 may be advantageously implemented in connection with the system 200, described previously in connection with FIG. 2, and/or any appropriate system to meet the design criteria of a particular application. The method 300 generally includes a plurality of blocks or steps that may be performed serially. As will be appreciated by one of ordinary skill in the art, the order of the steps shown in FIGS. 3-7 are exemplary and the order of one or more steps may be modified within the spirit and scope of the present invention. Additionally, the methods illustrated may be performed in at least one non-serial (or non-sequential) order, and one or more steps may be omitted to meet the design criteria of a particular application.

Block 302 generally represents an entry point into the method 300. A transmitter (e.g., 104) may be provided at step 304. In at least one embodiment, the transmitter may include a programmable (i.e., writable) memory (e.g., 212). In general, the transmitter may be configured to identify the air pressure of a tire (e.g., 106). In at least one embodiment, the transmitter may identify the air pressure via a signal generated by a sensor (e.g., 240) electronically coupled to the transmitter. In another embodiment, the transmitter may be integrated with a sensor (i.e., sensing element). However, the transmitter may identify the air pressure using any appropriate technique and/or apparatus to meet the design criteria of a particular application. Similarly, the transmitter may be implemented in any appropriate configuration to meet the design criteria of a particular application.

A receiver (e.g., 102) may be provided at step 306. In general, the receiver may be configured to be coupled to the vehicle (e.g., 100) and generally comprises a memory (e.g., 204) having a set of unique identifiers (e.g., ID1-IDn) stored therein. However, the receiver may be implemented in any appropriate configuration to meet the design criteria of a particular application.

As generally represented by steps 308-312, one or more embodiments of the present invention may optionally include a tool (e.g., 230) electronically coupled to the transmitter (i.e., wired, wirelessly, etc.). In such an embodiment, an operator initiated signal may be transmitted from the tool to the transmitter, as generally represented by step 310. Furthermore, a pairing request may be transmitted from (i.e., by) the transmitter to the receiver in response to the operator initiated signal, as generally represented by step 312.

At step 314, a locally unique identifier may be selected (i.e., determined) from the set of identifiers stored in the memory of the receiver in response to any appropriate trigger, such as the pairing request signal, and using any appropriate technique and/or apparatus to meet the design criteria of a particular application. In general, the receiver may select the identifier from among the members of the set of locally unique identifiers stored in the memory. In one embodiment, the locally unique identifier includes a tire identifier.

At step 316, the locally unique identifier may be written to (i.e., stored in) the programmable memory of the transmitter. In one embodiment of the present invention, the transmitter may comprise a low frequency receiver (e.g., 216) and the locally unique identifier may be written to the programmable memory of the transmitter using a low frequency initiator (e.g., the low frequency initiator 208 of the receiver 102) and the low frequency receiver. In another embodiment of the present invention, the transmitter may comprise an antenna (e.g., 214) and the locally unique identifier may be written to the programmable memory of the transmitter via unidirectional and/or bi-direction communication between the transmitter antenna and an antenna of a receiver (e.g., 206). In yet another embodiment having the tool of step 308, writing the locally unique identifier to the programmable memory of the transmitter may further include transmitting the locally unique identifier to the low frequency receiver of the transmitter (e.g., 216) via a low frequency initiator (such as the low frequency initiator 208 of the receiver 102) in response to pairing request signal. The code 207 may also be sent to the transmitter using any of the techniques described above. However, the locally unique identifier and the code of the receiver may be written to the programmable memory of the transmitter in response to any appropriate trigger and using any appropriate technique and/or apparatus to meet the design criteria of a particular application.

At step 318, the transmitter may transmit to the receiver a signal based on the locally unique identifier 205i, the code 207, and the air pressure and/or temperature in (i.e., of) the tire.

Block 320 generally represents an exit point out of the method 300.

In at least one non-limiting embodiment of the present invention, the step of determining a locally unique identifier from the set of identifiers and the code stored in the memory of the receiver (i.e., step 314) and/or the step of writing the locally unique identifier and/or code to the programmable memory of the transmitter (i.e., step 316) may be performed prior to installation of the receiver in the vehicle. In at least one other non-limiting embodiment, the step of determining a locally unique identifier from the set of unique identifiers and/or determining the code stored in the memory of the receiver (i.e., step 314) and/or the step of writing the identifier and/or code to the programmable memory of the transmitter (i.e., step 316) may be performed prior to installation of the transmitter in the tire.

Referring still to FIG. 3, a flow diagram of a method 350 for pairing a transmitter (e.g., 104) and a receiver (e.g., 102) in a system (e.g., 200) for monitoring air pressure in a tire (e.g., 106) of a vehicle (e.g., 100) according to one embodiment of the present invention is shown. As illustrated, the method 350 may be a subset of the method 300 and may comprise one or more of the steps 308, 310, 312, 314 and 316. In general, the method 350 may be advantageously implemented in connection with the system 200, described previously in connection with FIG. 2, and/or any appropriate system to meet the design criteria of a particular application. The method 350 generally includes a plurality of blocks or steps that may be performed serially. As will be appreciated by one of ordinary skill in the art, the order of the steps shown in FIG. 3 is exemplary and the order of one or more steps may be modified within the spirit and scope of the present invention. Additionally, the steps of the method 350 may be performed in at least one non-serial (or non-sequential) order, and one or more steps may be omitted to meet the design criteria of a particular application.

Referring now to FIG. 4, a flow diagram illustrating a method of generating and transmitting a signal according to an embodiment of the present invention is shown. A locally unique ID and a receiver code are received by the transmitter and stored, as in block 402. At least one parameter is sensed and a data portion for a transmission signal is generated, as in block 404.

The ID is encrypted with the code and the result used to generate an encrypted portion for a transmission signal, as in block 406. Because the goal of this encryption is to produce an encrypted portion that is relatively unique rather than to produce an encrypted portion that is difficult to break, the encryption technique need not be complex. Preferably, a symmetric key algorithm may be used such as, for example, a simple bitwise exclusive—or operation. If the ID and code are not the same length, the shorter can be repeated.

A signal is transmitted, as in block 408. The encrypted portion is combined with the data portion to form a transmission signal. This transmission signal is modulated for transmission from an antenna to the receiver. Various encoding and modulation schemes are well known in the art. The process of sensing, encrypting, and transmitting may be repeated for continuous monitoring. Alternatively, the encrypting step may be performed once and the encrypted portion stored.

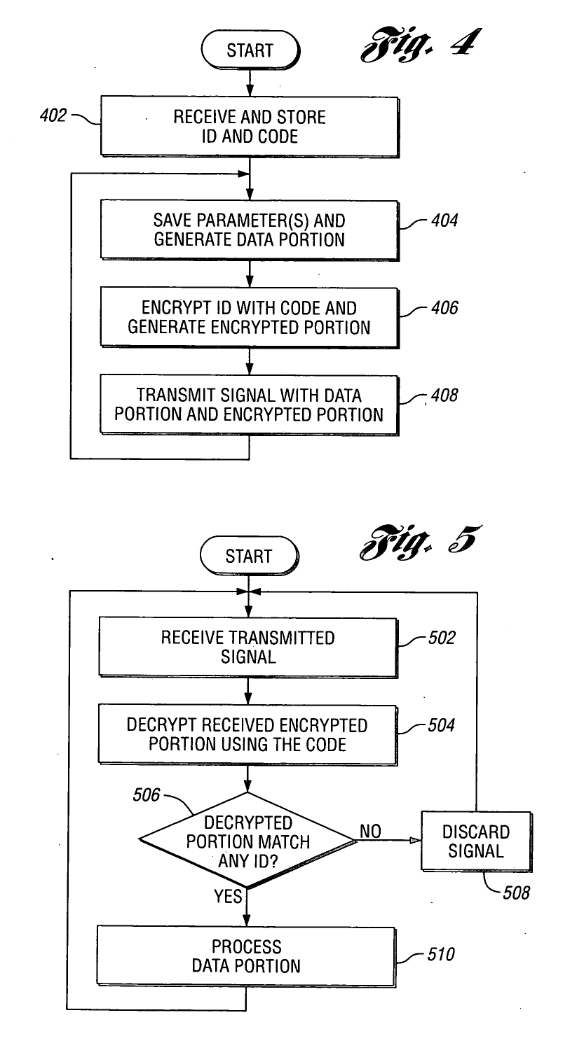

Referring now to FIG. 5, a flow diagram illustrating receiving a signal according to an embodiment of the present invention is shown. The receiver receives a transmitted signal, as in block 502. The receiver decrypts the encrypted portion using the code, as in block 504. The decrypted portion is then compared to a list of known IDs for transmitters associated with the receiver, as in block 506. If there is no match, the received signal is discarded, as in block 508. If a match occurs, the data portion of the received signal is processed, as in block 510. Processing may include determining whether or not one or more parameters are within one or more thresholds and, if not, triggering a visual or audio alarm. The algorithm may then check for the next received signal.

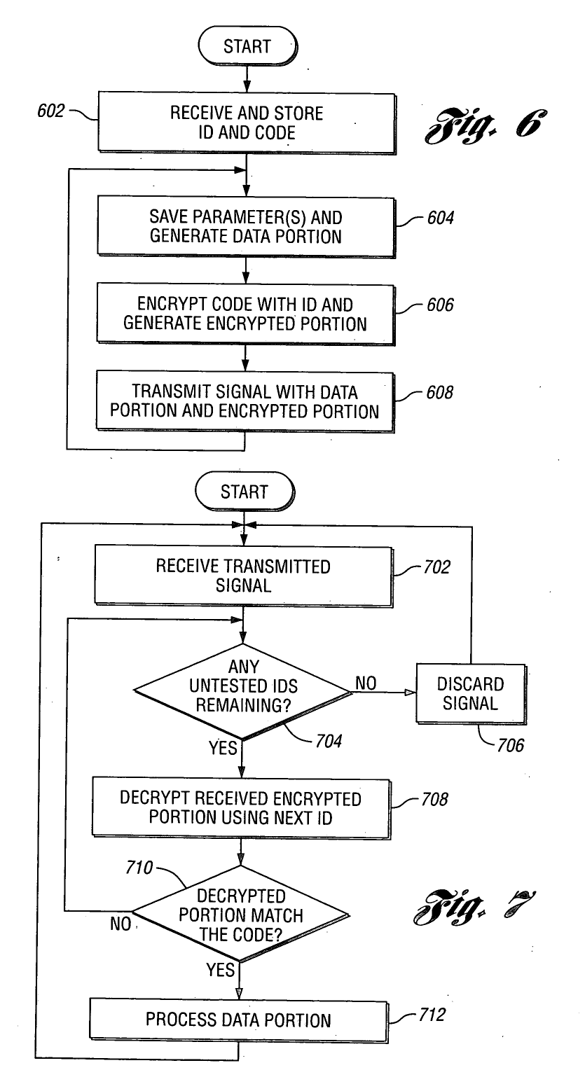

Referring now to FIG. 6, a flow diagram illustrating an alternative method of generating and transmitting a signal according to an embodiment of the present invention is shown. A locally unique ID and a receiver code are received by the transmitter and stored, as in block 602. At least one parameter is sensed and a data portion for a transmission signal is generated, as in block 604.

The code is encrypted with the locally unique ID and the result used to generate an encrypted portion for a transmission signal, as in block 606. Once again, a simple symmetric key algorithm may be used. If the ID and code are not the same length, the shorter can be repeated. A signal including the encrypted portion and the data portion is transmitted, as in block 608.

Referring now to FIG. 7, a flow diagram illustrating receiving a signal according to an alternative embodiment of the present invention is shown. The transmitted signal is received, as in block 702. A check is made to determine if any possible untested IDs remain, as in block 704. If not, no match was found and the received signal is discarded, as in block 706. If any IDs remain, the received encrypted portion is decrypted using the next untested ID, as in block 708. A check is made as to whether or not the decrypted portion matches the receiver code, as in block 710. If not, the algorithm checks again for any remaining untested IDs. If the decrypted portion matches the code, the data portion is processed, as in block 712. Processing may include determining whether or not one or more parameters are within one or more thresholds and, if not, triggering a visual or audio alarm. The algorithm may then check for the next received signal.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for monitoring at least one parameter of a tire of a vehicle, the system comprising:
a receiver having a storage memory comprising a set of locally unique identifiers and a code, the receiver configured to:
receive a transmitted signal comprising an encrypted portion and a data portion;
decrypt the encrypted portion using at least one of the code and the locally unique identifiers to produce a decrypted portion;
determine if the decrypted portion matches one of the code and the locally unique identifiers; and
process the data portion when the decrypted portion matches one of the code and the locally unique identifiers; and
a transmitter corresponding to the tire and having a programmable memory storing the code and one of the set of locally unique identifiers, the transmitter configured to:
generate the encrypted portion based on the stored locally unique identifier and the code;
generate the data portion based on sensing the at least one parameter of the tire; and
transmit the transmitted signal comprising the encrypted portion and the data portion.

2. The system of claim 1 wherein the transmitter generates the encrypted portion by encrypting the code with the stored locally unique identifier.

3. The system of claim 2 wherein the receiver decrypts the encrypted portion using one of the set of locally unique identifiers and wherein the receiver determines if the decrypted portion matches the code.

4. The system of claim 1 wherein the transmitter generates the encrypted portion by encrypting the stored locally unique identifier with the code.

5. The system of claim 4 wherein the receiver decrypts the encrypted portion using the code and wherein the receiver determines if the decrypted portion matches a member of the set of locally unique identifiers.

6. The system of claim 1 wherein the transmitter further comprises a low frequency receiver and the transmitter is configured to receive at least one of the code and a member of the set of locally unique identifiers via the low frequency receiver.

7. The system of claim 6 wherein the receiver further comprises a low frequency initiator for transmitting at least one of the code and a member of the set of locally unique identifiers via the low frequency receiver.

8. The system of claim 7 further comprising a tool electronically coupled to the transmitter for transmitting an operator initiated signal to the transmitter, wherein the transmitter transmits a pairing request signal to the receiver in response to the operator initiated signal.

9. A method for monitoring a vehicle tire comprising:
storing in a transmitter a locally unique tire identifier and a code, the transmitter associated with the monitored vehicle tire;
generating an encrypted portion of a transmission signal based on the locally unique tire identifier and the code;
generating a data portion of the transmission signal based on at least one parameter sensed for the vehicle tire; and
transmitting from the transmitter the transmission signal.

10. The method of claim 9 wherein generating the encrypted portion comprises encrypting the locally unique tire identifier with the code.

11. The method of claim 10 further comprising:
receiving the transmission signal;
decrypting the encrypted portion of the transmission signal with the code to generate a decrypted portion;
comparing the decrypted portion with at least one of a set of locally unique identifiers; and
processing the data portion of the transmission signal if the decrypted portion matches the at least one of the set of locally unique identifiers.

12. The method of claim 9 wherein generating the encrypted portion comprises encrypting the code with the locally unique tire identifier.

13. The method of claim 12 further comprising:
receiving the transmission signal;
decrypting the encrypted portion of the transmission signal with at least one of a set of locally unique identifiers;
comparing the decrypted portion with the code; and
processing the data portion of the transmission signal if the decrypted portion matches the code.

14. A method for monitoring a particular tire on a particular vehicle, the particular vehicle one of a plurality of vehicles, the particular tire one of a plurality of monitored tires on the plurality of vehicles, the method comprising:
assigning to the particular tire one of at least one locally unique identifiers, each locally unique identifier different from any other tire identifier associated with a receiver on the particular vehicle but not necessarily different from any other tire identifier associated with a different vehicle in the plurality of vehicles;
assigning to the receiver a unique code;
receiving in the receiver a transmission signal including an encrypted portion and a data portion;
decrypting the encrypted portion using at least one of the code and at least one of the locally unique identifiers to generate a decrypted portion;
comparing the decrypted portion with at least one of the code and the at least one of the locally unique identifiers and, if the comparison results in a match, processing the data portion.

15. The method of claim 14 wherein decrypting the encrypted portion comprises using the code as a decryption key and wherein the decrypted portion is compared with each of the at least one locally unique identifiers until the comparison results in a match.

16. The method of claim 14 wherein decrypting the encrypted portion comprises using the each of the at least one locally unique identifiers as a decryption key, in turn, and wherein the decrypted portion is compared with the code until the comparison results in a match.

17. The method of claim 14 further comprising:
storing within a transmitter associated with the particular tire the code and the one of at least one locally unique identifiers assigned to the particular tire;
sensing at least one parameter of the particular tire;
generating the data portion based on the at least one sensed parameter;
generating the encrypted portion by encrypting the code with the stored locally unique identifier; and
transmitting the transmission signal including the encrypted portion and the data portion.

18. The method of claim 14 further comprising:
storing within a transmitter associated with the particular tire the code and the one of at least one locally unique identifiers assigned to the particular tire;
sensing at least one parameter of the particular tire;
generating the data portion based on the at least one sensed parameter;
generating the encrypted portion by encrypting the stored locally unique identifier with the code; and
transmitting the transmission signal including the encrypted portion and the data portion.
